(19) United States
(12) Patent Application Publication
(10) Pub. No.: US 2025/0390594 A1
(43) Pub. Date: Dec. 25, 2025

(54) DYNAMIC ACCOUNT-RELATED ACTION SYSTEM WITH AUTOMATED PROCESSING OF DATA STRUCTURES

(71) Applicant: Dell Products L.P., Round Rock, TX (US)

(72) Inventors: Abhishek Mishra, Bangalore (IN); Vivek Bhargava, Bangalore (IN); Ajith Navada, Davangere District (IN)

(21) Appl. No.: 18/751,555

(22) Filed: Jun. 24, 2024

(51) Int. Cl. G06F 21/62

(52) U.S. Cl. CPC G06F 21/6218

(57) ABSTRACT

Methods, apparatus, and processor-readable storage media for a dynamic account-related action system with automated processing of data structures are provided herein. An example computer-implemented method includes detecting an occurrence of at least one designated event pertaining to at least one user by processing a first set of one or more data structures including user-related data; identifying one or more account-related assets associated with the user(s) by processing a second set of one or more data structures including asset-related data; determining one or more account-related actions to be executed, in connection with at least a portion of the account-related asset(s), in response to detecting the occurrence of the designated event(s); automatically executing at least a portion of the determined account-related action(s); and performing one or more additional automated actions related to the determined account-related action(s) and based on the at least a portion of the automatically executed account-related action(s).

### BACKGROUND

When a user leaves an enterprise and/or transitions within an enterprise, one or more enterprise-related accounts associated with that user often remain activated and/or accessible, which can create security risks. Further, conventional account management techniques commonly fail to effectively handle such scenarios, resulting in security issues and other resource-intensive consequences.

### SUMMARY

Illustrative embodiments of the disclosure provide dynamic account-related action systems with automated processing of data structures.

An exemplary computer-implemented method includes detecting an occurrence of at least one designated event pertaining to at least one user by processing at least a first set of one or more data structures comprising user-related data, and identifying one or more account-related assets associated with the at least one user by processing at least a second set of one or more data structures comprising asset-related data. The method also includes determining one or more account-related actions to be executed, in connection with at least a portion of the one or more account-related assets, in response to detecting the occurrence of the at least one designated event pertaining to the at least one user. Additionally, the method includes automatically executing at least a portion of the one or more determined account-related actions, and performing one or more additional automated actions related to the one or more determined account-related actions and based at least in part on the at least a portion of the one or more determined account-related actions automatically executed.

Illustrative embodiments can provide significant advantages relative to conventional account management techniques. For example, problems associated with security issues and resource-intensive ex post facto efforts are overcome in one or more embodiments through automatically managing user account privileges based on event monitoring and related data structure processing.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated management of user account privileges in an illustrative embodiment.

FIG. 2 shows an example execution workflow in an illustrative embodiment.

FIG. 3 shows example pseudocode for implementing at least a portion of a dynamic account-related action system with automated processing of data structures in an illustrative embodiment.

FIG. 4 is a flow diagram of a process for automated management of user account privileges in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

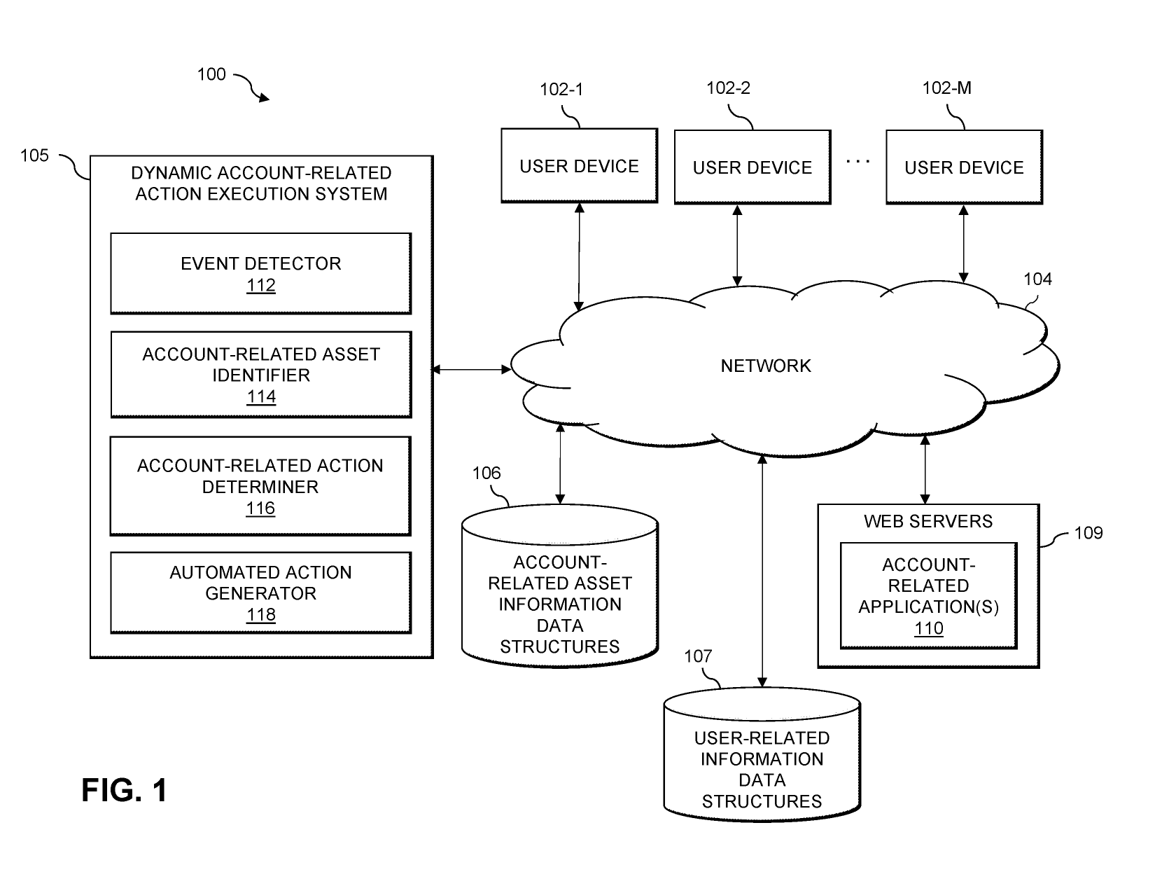

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is dynamic account-related action execution system 105 and one or more account-related applications 110 (e.g., enterprise account applications, vendor account applications, protected resource-related account applications, etc.) executing on a set of web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the dynamic account-related action execution system 105 can have associated account-related asset information data structures 106 configured to store data pertaining to asset information associated with various accounts and users corresponding thereto (e.g., asset identification information, asset access information, asset authentication information, etc.). Also, the dynamic account-related action execution system 105 can have associated user-related information data structures 107 configured to store data pertaining to information associated various users within contexts of one or more enterprise structures, account privileges, temporal parameters, authentication operations, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The account-related asset information data structures 106 and/or user-related information data structures 107 in the present embodiment is implemented using one or more storage systems associated with the dynamic account-related action execution system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the dynamic account-related action execution system 105 are one or more input-output devices, which illustratively comprise keyboards, displays or other types of input-output devices in any combination. Such input-output devices can be used, for example, to support one or more user interfaces to the dynamic account-related action execution system 105, as well as to support communication between the dynamic account-related action execution system 105 and other related systems and devices not explicitly shown.

Additionally, the dynamic account-related action execution system 105 in the FIG. 1 embodiment is assumed to be implemented using at least one processing device. Each such processing device generally comprises at least one processor and an associated memory, and implements one or more functional modules for controlling certain features of the dynamic account-related action execution system 105.

More particularly, the dynamic account-related action execution system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the dynamic account-related action execution system 105 to communicate over the network 104 with the user devices 102, and illustratively comprises one or more conventional transceivers.

The dynamic account-related action execution system 105 further comprises an event detector 112, an account-related asset identifier 114, an account-related action determiner 116, and an automated action generator 118.

It is to be appreciated that this particular arrangement of elements 112, 114, 116 and 118 illustrated in the dynamic account-related action execution system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for automatically managing user account privileges based on event monitoring and related data structure processing involving user devices 102, account-related asset information data structures 106, and/or user-related information data structures 107 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of dynamic account-related action execution system 105, account-related asset information data structures 106, user-related information data structures 107, and web servers 109 can be on and/or part of the same processing platform.

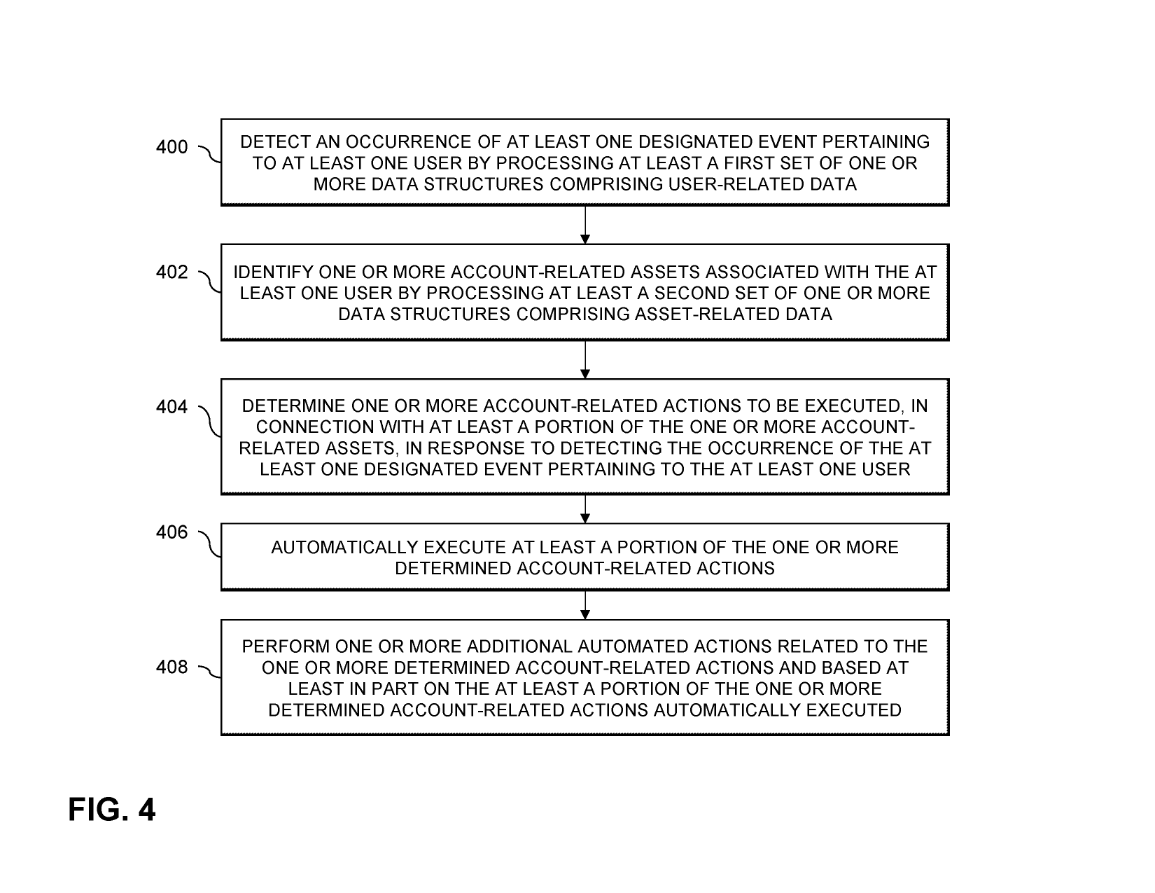

An exemplary process utilizing elements 112, 114, 116 and 118 of an example dynamic account-related action execution system 105 in computer network 100 will be described in more detail with reference to the flow diagram of FIG. 4.

Accordingly, at least one embodiment includes automated management of user account privileges. As noted, when a user (e.g., a team member) leaves an enterprise, one or more enterprise-related accounts associated with that user may be deactivated. However, such accounts may include means of user access outside of enterprise control, which can create confusion and challenges with respect to appropriately revoking account access. For example, an enterprise team member may have an account with a partner of the enterprise, the account being initiated using the team member’s enterprise account identifier (ID). Subsequently, even if the team member’s enterprise account is deactivated, the account with the partner of the enterprise may be active, e.g., because that account may be independent of an enterprise-related authentication protocol and can be accessed through devices outside of the enterprise network.

As such, and as detailed herein, at least one embodiment includes enabling and/or implementing intelligent device interactions which can reciprocate changes of authentication information (e.g., passwords) and user account access via an automated workflow. Such an automated workflow can include providing and/or initiating actionable input(s) at different moments and/or instances during a notice period of a particular user to enable a seamless exit and/or deactivation process. Further, as also described herein, in contrast to disadvantageous conventional techniques, one or more embodiments include avoiding and/or precluding information mismatch and communication gaps with respect to determining user account accesses and/or assets, and determining the process(es) needed to complete appropriate account transfers and/or deactivations.

At least one embodiment includes generating and/or implementing a smart tracking system, which governs enterprise-related account ownership associated with enterprise users, as well as an intelligent machine communication process which schedules and/or initiates communications with actionable input(s) at different times during notice periods of enterprise users. As further detailed herein, such an embodiment can include account access tracking, automated communication notifications, and form completion. With respect to account access tracking, one or more embodiments include monitoring and/or tracking enterprise-related account access of enterprise users (e.g., enterprise team members) once notice is given and/or received regarding the users’ departure from the enterprise (e.g., user resignation, user retirement, etc.). Such tracking can include, for example, consolidating multiple enterprise-related user accounts and related access information into at least one centralized repository.

With respect to automated communication notifications, one or more embodiments can include triggering, upon obtaining information pertaining to a notice period associated with a user’s departure from the enterprise, at least one automated communication (e.g., an automated email) to the departing user, wherein the at least one automated communication includes one or more action items and related procedures to be followed and/or completed by the user prior to departure in connection with account-related services. In such an embodiment, multiple automated communications can be sent to the departing user at different intervals during the notice period, detailing different action items across the communications and/or repeating and/or reminding the departing user of one or more actions items still to be completed by the user.

Additionally, with respect to form completion, at least one embodiment includes generating and/or implementing at least one intake form for a digital sign-off of a departing enterprise user after completion of any asset transfer(s) associated with enterprise-related user accounts to ensure accountability and completion.

Further, one or more embodiments can include repeating at least portions of the account access tracking, automated communication notification, and form completion processes noted above for one or more enterprise users receiving ownership and/or control of any assets associated with an enterprise-related account of a departing user. For example, such an embodiment can include repeating at least a portion of such processes to ensure that all necessary credentials and recovery of accounts have been transferred to the at least one enterprise user serving as the new owner.

In at least one embodiment, implementing automated communication notifications can include utilizing at least one trigger mechanism which initiates the process once a relevant event occurs and/or is detected (e.g., upon processing a user resignation notice on an enterprise management system). Additionally, such an embodiment includes using at least one application programming interface (API) for asset tracking. Such an API can track, for example, enterprise partner management accounts and access information associated with at least one given enterprise user, and can be used to gather and/or collect information about hardware, software, access privileges, and other related assets.

Additionally, once triggered, at least one embodiment includes generating messages that consolidate all required action details relative to the triggering event. Such messages can include, for example, relevant information (e.g., articles, instructional guides, etc.) for the required action(s). One or more embodiments also include back-tracking capabilities, which includes monitoring the actions completed by the user as well as the status of pending actions. In such an embodiment, reminders can be generated and sent to the user for the actions yet to be completed. At least one embodiment can additionally include tracking and/or monitoring stories covered by the enterprise user during his or her tenure with the enterprise. Such tracking and/or monitoring can provide a comprehensive view of the work done by the enterprise, facilitating more complete and accurate transfers of account-related asset ownership. As used herein, a story refers to a description of a feature and/or functionality from the perspective of an end user. A story can capture, for example, what the user wants to achieve and why, providing clear and actionable requirements for a development team. Also, the structure of a user story can include, e.g., the following format: “As a [type of user], I want [a specific feature] so that [a benefit or reason].”

As noted above, one or more embodiments include implementing at least one trigger mechanism. In such an embodiment, once a user departure (e.g., a user resignation) has been mutually accepted by the user and the enterprise, a final day (with the enterprise) for the user is determined and/or established, and a notice period is initiated based thereon. In an example embodiment, details pertaining to the final day and/or the notice period are uploaded and/or entered into an enterprise management system.

At least one embodiment includes preprocessing data collected from different sources in connection with at least one dependent API. Such data sources can include, for example, enterprise management systems and/or software, project software, pivotal cloud foundry (PCF) code logs and Confluence pages, etc. In such an embodiment, the data collection can be triggered by a notification (e.g., a system-generated email) that a given enterprise user is leaving the enterprise, and the data collection process can encompass data related to assets owned and/or controlled by the given user, data related to dependencies associated with the given user, etc.

By way merely of illustration, consider the following example embodiment with respect to this type of data collection. Enterprise partner account data (e.g., vendor account data) can be collected from at least one enterprise partner management system and/or team, and the example embodiment can include processing such data to identify the accounts which a particular enterprise user owns and/or controls, including determining whether such accounts are active or not. Based at least in part on such determinations, at least one secondary action email template can be automatically generated (e.g., including a sequence of instructions).

Additionally, in conjunction with such an example embodiment, the above-noted steps can be incorporated and/or included as part of at least one checklist which can be created and updated based on the completion of each such step. Such a checklist can be viewed and/or updated, for example, on demand using at least one enterprise management system and/or platform.

Also, one or more embodiments include identifying at least one action and one or more proposed steps related thereto using at least one entity containment dictionary. Such an entity containment dictionary can provide the containment of various components inside a workflow and/or entity. For example, assume that a service account request is raised from a service, and a service account requires an owner as well as a secondary owner. The corresponding entity containment dictionary, along with an entity name dictionary and action verb visual dictionary, can be used to create one or more action and/or message sequences. By way of additional example, a vendor account for a given vendor is identified as being owned and/or controlled by a particular enterprise user, one or more projects that the particular enterprise user has been involved with during his or her tenure with the enterprise are identified, the devices and other enterprise-related assets owned and/or controlled by the particular enterprise user are identified, etc., and data pertaining to such identifications are collected and/or stored.

Additionally, in one or more embodiments, the at least one entity containment dictionary can be used in conjunction with at least one entity name dictionary and at least one action verb message dictionary to create one or more actionable messages (e.g., email notifications pertaining to one or more actions to be completed by the particular enterprise user). Entity containment details can be extracted pertaining to how users can use the terms related to each other. Also, an action verb dictionary can be leveraged to form and/or determine an association with each of multiple actions, and a choreographed message sequence that is an indicator for at least a portion of the multiple actions can be determined and/or generated. The action sequence indicator can involve, e.g., interaction between two entities and a movement that is in specific direction.

At least one embodiment can also include generating and/or outputting one or more consolidated messages in connection with initiating an account and/or other asset ownership transfer process among enterprise users. With respect to a single user interaction scenario, at least one look ahead parametric needs table is consulted and used to determine if all required parameters are satisfied and/or completed. In an example scenario wherein there are one or more parameters that have not been satisfied and/or completed, then one or more embodiments include automatically rejecting the corresponding request and reverting with a notification highlighting the one or more parameters to be satisfied and/or completed. Such a notification, in addition to identifying the one or more parameters to be satisfied and/or completed, can also identify, using at least one entity containment dictionary, at least one action pertaining to satisfying and/or completing the one or more parameters and one or more proposed steps related to the at least one action.

In a situation where multiple possible actions can be suggested (e.g., when a service account has two owners, and one person can be in a notice period and the other person is a secondary owner, recommend alternative resolution options can be recommended), one or more embodiments include ranking the actions, and outputting a notification (e.g., an email) to the particular enterprise user which presents the ranked actions to the user. By way of example, at least one embodiment can also include accounting for one or more service level agreements (SLAs) associated with one or more of the multiple possible actions, and automatically initiated a notification at a point of a notice period associated with the particular enterprise user in accordance with the one or more SLAs. Additionally, based on the user selection of at least one of the ranked action, one or more embodiments include proceeding with and/or initiating the at least one selected action.

One or more embodiments can also include assigning a severity value to each of the multiple actions and/or each of the action categories associated with the multiple possible actions. Such severity values can be used, for example, to define which actions can be automated and which actions require human intervention and/or approval, as well as to estimate the time by which certain actions should be completed. By way of example, such an embodiment can include using at least one graph data structure to perform a severity level assignment process such as the following. A severity level is assigned to each action category, defining which actions can be automated and which actions require human intervention and/or approval, and estimating a time for completion. Such assignments are performed until the end of each of multiple relevant paths in the at least one graph data structure is reached. If any of the paths fail, such an embodiment includes backtracking to the most recent branch in the path, and selecting the next highest ranked action in the path. By way of example, a path might fail if a resolution is not solved. In such a scenario, the workflow returns to the previous step and the user is asked to perform the action. For instance, if a user raises an incident for an account transfer, and if it fails then the path can be updated and the user can attempt to perform this task again. Additionally, the process can continue until the end of one or more paths is reached and/or there are no more paths to traverse. Further, based at least in part on the assigned severity levels, one or more automated messages can be triggered and/or initiated with corresponding priority to ensure that the actions are completed on time.

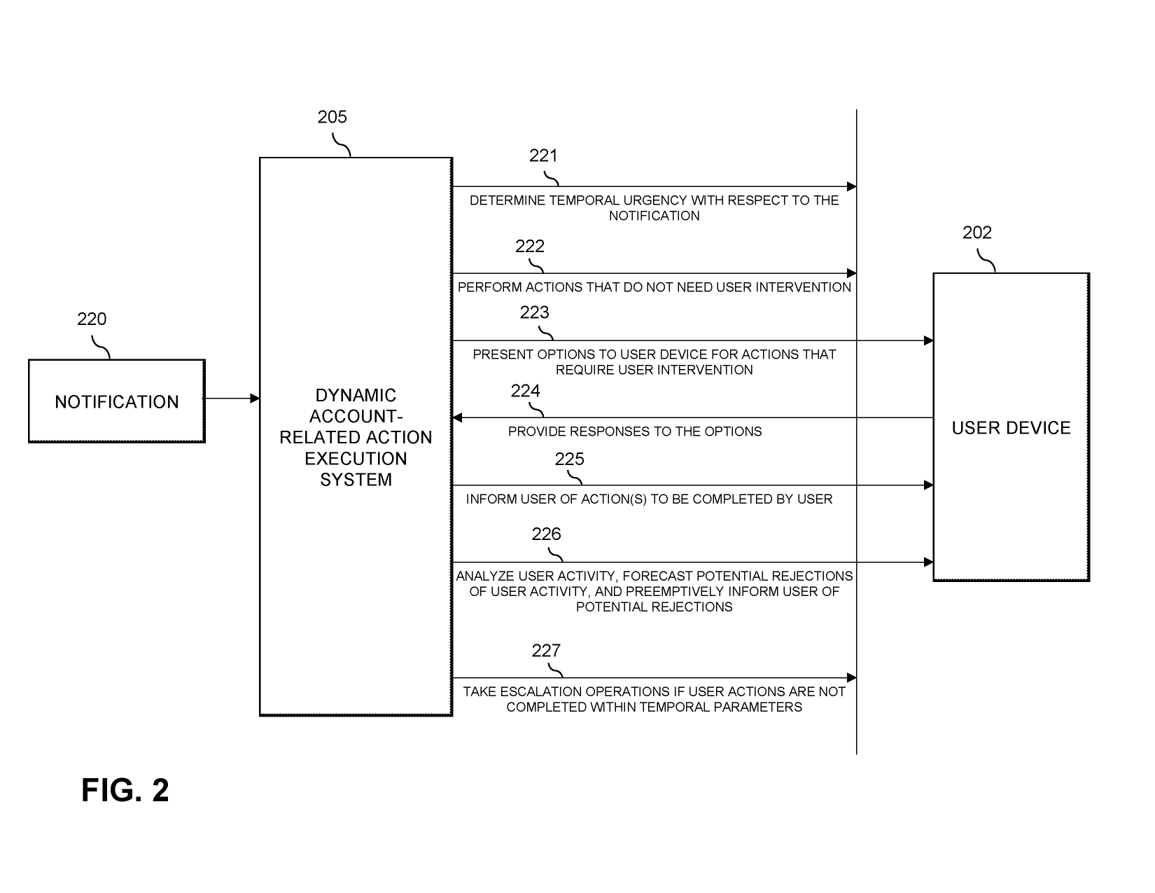

FIG. 2 shows an example execution workflow in an illustrative embodiment. By way of illustration, FIG. 2 depicts dynamic account-related action execution system 205 and user device 202. As illustrated, the dynamic account-related action execution system 205 obtains and/or processes notification 220. By way merely of example, an example of notification 220 might include the following message:

“A Database Service Account Owner Change can be requested by any user, for themselves or for others through an Information Technology (IT) Service Catalog item. If the request is submitted by the user’s manager, the request will skip the manager approval; otherwise, the request will need to be approved by the user’s manager or the manager’s delegate. A process to request a Service Account Owner Change for Structured Query Language (SQL) server databases is separately defined herein.”

Referring again to FIG. 2, in step 221, the dynamic account-related action execution system 205 determines temporal urgency with respect to the notification 220, and in step 222, the dynamic account-related action execution system 205 automatically performs one or more actions that do not need user intervention. Additionally, in step 223, for one or more actions that do require user intervention, the dynamic account-related action execution system 205 generates and presents one or more options to the user via user device 202.

As also depicted in FIG. 2, in step 224, the user device 202 provides responses to the one or more options presented in step 223, and the dynamic account-related action execution system 205 analyzes the responses and determines the skill level of the user associated with user device 202 in connection with the responses and/or options. Based at least in part on this analysis, in step 225, the dynamic account-related action execution system 205 informs the user, via user device 202, of the specific action(s) to be completed by the user (e.g., based at least in part on the user’s user profile and/or the user selection of one or more options in connection with step 223). Additionally, in step 226, the dynamic account-related action execution system 205 monitors and analyzes the user responses and/or activity, forecasts any potential rejections of such user responses and/or activity, and preemptively informs the user (via user device 202) of any such potential rejections. Further, in step 227, the dynamic account-related action execution system 205 takes one or more escalation operations (e.g., sending emails to superiors, creating tasks in task management systems, etc.) if it is determined that the user action(s) are not completed within one or more designated temporal parameters.

With respect to a group interaction scenario, an automated message can be sent to a group of enterprise users (e.g., via an enterprise team broadcast message). In such a context, if one of the enterprise users fails to respond to the message within a given timeframe, then at least one embodiment can include determining and/or identifying the user and/or entity (e.g., a manager or administrator with sufficient privileges) accountable for the enterprise user in question, at least one backup user and/or entity, and/or waiting until one of the members of the group of enterprise users owns the action(s) associated with the message (e.g., accountable for the action(s) and the action(s) is/are assigned against his or her name). Thereafter, such a context would become a single user interaction, such as detailed above. Additionally, in one or more embodiments, the target user can be switched and/or modified, and direct communication with the new target user can commence subsequent thereto.

At least one embodiment can also include tracking different stages during a given notice period and/or other related cycle time. In such an embodiment, metadata can be collected, using one or more APIs associated with one or more relevant systems, based at least in part on one or more actions completed and one or more pending actions which remain. More particularly, such an embodiment can include monitoring data pertaining to one or more user actions and identifying one or more corresponding triggers to expedite at least a portion of the process in question (e.g., deactivating and/or transferring user accounts as part of the user’s departure from an enterprise). Additionally, such an embodiment then includes transmitting at least a portion of the data to at least one enterprise management system and/or platform and updating at least one checklist related to the process in question. Further, such an embodiment can include determining the potential risk if the given user does not perform the action(s) on time, and determining one or more remedial options based at least in part thereon. Also, based on user consent and the degree of detail to be shared, such an embodiment can include proceeding to the next course of action(s) upon reaching finality of the given action(s) (e.g., the action(s) is/are completed or at least one of the remedial options is performed).

As also detailed herein, at least one embodiment can include tracking account credentials in conjunction with implementing and/or maintaining at least one repository. Such an embodiment includes monitoring and/or tracking stories covered by an enterprise user during his or her tenure with the enterprise, which can provide a comprehensive view of work done by the enterprise user and can facilitate more efficient transfer of ownership of one or more related accounts. Additionally such an embodiment can include interpreting data in one or more data sources such as, e.g., a software development and/or project tracking repository. Such data can be collected based at least in part on the project(s), process(es) and/or assignment(s) that the enterprise user has participated in. Using such collected data, one or more embodiments can include suggesting one or more account transfer options and/or alternatives, as well as estimating and/or determining how much time such actions would take.

Accordingly, as detailed herein, one or more embodiments include implementing a secured process of ownership transfer and/or deactivation of enterprise-related user accounts. Also, such an embodiment can include determining and presenting, to one or more users and/or entities accountable for a given enterprise user, one or more options related to the ownership transfer and/or deactivation of the enterprise-related user accounts based at least in part on probability values derived from past occurrences of similar and/or related options. Further, at least one embodiment can include mapping context responses by one or more users to one or more known situations, and using such mapping to make one or more decisions related to the ownership transfer and/or deactivation of the enterprise-related user accounts. Relatedly, such an embodiment can include implementing automated in-context learning based at least in part on the context and the user for similar situations, wherein the automated in-context learning generates responses and/or makes predictions based at least in part on specific context.

Consequently, one or more embodiments can include reducing incidents related to account ownership and/or access in connection with departed and/or departing enterprise users, reducing knowledge gaps associated with account transfers, as well as reducing infrastructure costs and duplication of accounts.

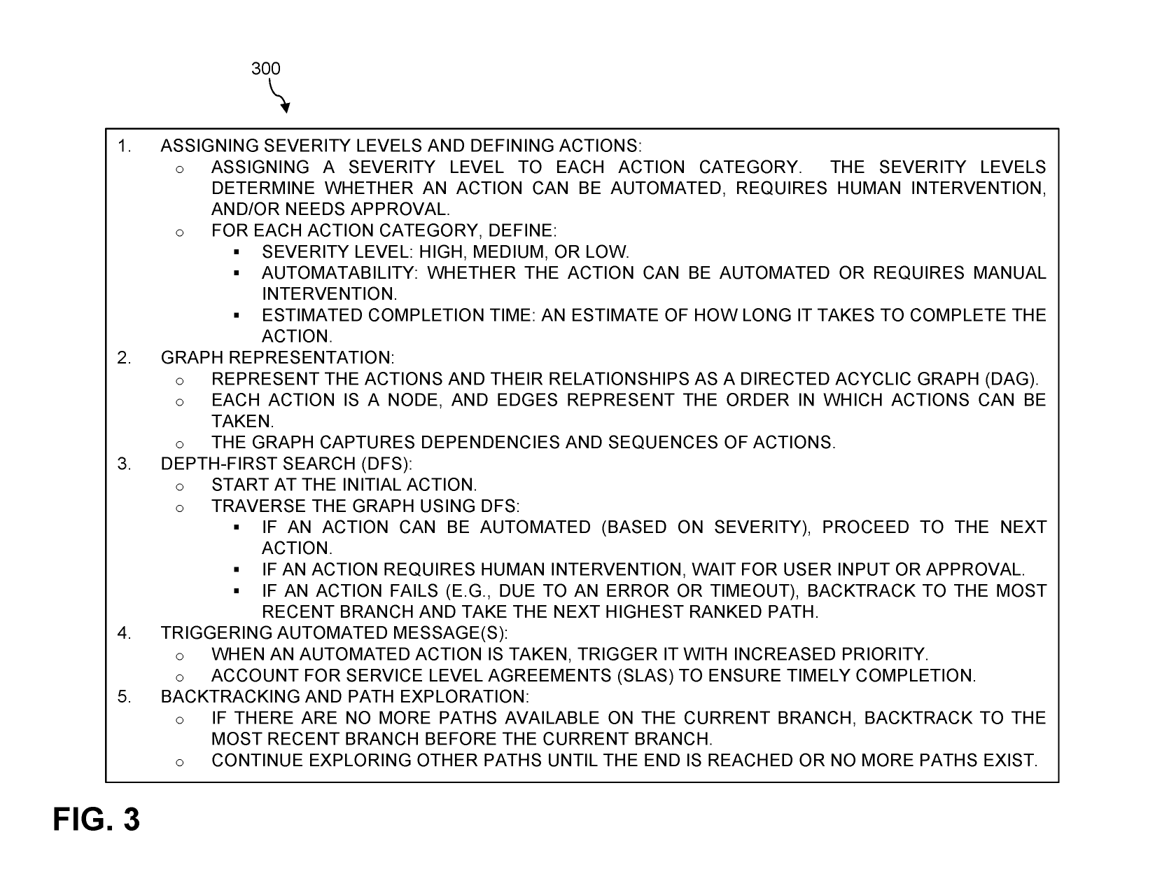

FIG. 3 shows example pseudocode for implementing at least a portion of a dynamic account-related action system with automated processing of data structures in an illustrative embodiment. In this embodiment, example pseudocode 300 is executed by or under the control of at least one processing system and/or device. For example, the example pseudocode 300 may be viewed as comprising a portion of a software implementation of at least part of dynamic account-related action execution system 105 of the FIG. 1 embodiment.

The example pseudocode 300 illustrates assigning severity levels and defining actions. More particularly, at least one embodiment can include starting by assigning a severity level to each action category, wherein such severity levels determine whether an action can be automated, requires human intervention, and/or needs approval(s). For each action category, such an embodiment includes defining a severity level (e.g., high, medium, or low (or any other relevant scale)), defining automatability (i.e., whether the action can be automated (e.g., sending an automated email) or requires manual intervention), and defining an estimated completion time (e.g., estimating how long it will take to complete the action).

The example pseudocode 300 also illustrates a graph representation step. More particularly, at least one embodiment includes representing the actions and their relationships as a directed acyclic graph (DAG), wherein each action is a node, and edges represent the order in which actions can be taken. Also, the DAG captures one or more dependencies and one or more sequences of actions. Further, example pseudocode 300 illustrates a depth-first search (DFS) step, which includes beginning at the initial action (e.g., “Select the course of action with the highest rank”), and traversing the DAG using DFS. If an action can be automated (based on the assigned severity level), at least one embodiment includes proceeding to the next action. If an action requires human intervention, such an embodiment includes waiting for user input or approval. If an action fails (e.g., due to an error or timeout), such an embodiment includes backtracking to the most recent branch and taking the next highest ranked path.

Additionally, the example pseudocode 300 also illustrates a step for triggering automated messages. When an automated action is taken (e.g., sending an email), the action is triggered with increased priority. Also, at least one embodiment includes accounting for one or more SLAs to ensure timely completion. Further, example pseudocode 300 illustrates a backtracking and path exploration step, wherein if there are no more paths available on the current branch, at least one embodiment includes backtracking until the most recent branch before the current branch. Such an embodiment also includes continuing to explore other paths until the end is reached or no more paths exist.

In connection with example pseudocode 300, consider, by way merely of illustration, an example scenario which includes the following actions: (1) Select the highest ranked course of action; (2) Send an actionable email to the user; (3) Wait for the user’s selection; and (4) Proceed based on the user’s selection. A corresponding graph, in such an example scenario, may include the following: (1) (2) (3) (4), wherein action (1) is automated, action (2) (e.g., an email) requires human intervention, action (3) depends on the user’s response, and action (4) proceeds based on the user’s choice. Additionally, in such an example embodiment, the severity level and estimated completion times would be defined for each action.

It is to be appreciated that this particular example pseudocode shows just one example implementation of a dynamic account-related action system with automated processing of data structures, and alternative implementations can be used in other embodiments.

FIG. 4 is a flow diagram of a process for automated management of user account privileges in an illustrative embodiment. It is to be understood that this particular process is only an example, and additional or alternative processes can be carried out in other embodiments.

In this embodiment, the process includes steps 400 through 408. These steps are assumed to be performed by the dynamic account-related action execution system 105 utilizing elements 112, 114, 116 and 118.

Step 400 includes detecting an occurrence of at least one designated event pertaining to at least one user by processing at least a first set of one or more data structures comprising user-related data. In at least one embodiment, detecting an occurrence of at least one designated event includes detecting an occurrence of at least one event indicating a change in status of the at least one user with respect to access to at least one of the one or more account-related assets. In such an embodiment, detecting an occurrence of at least one event indicating a change in status of the at least one user with respect to access to at least one of the one or more account-related assets can include detecting an indication of a departure of the at least one user from at least one corresponding enterprise by processing enterprise management data within the at least a first set of one or more data structures.

Step 402 includes identifying one or more account-related assets associated with the at least one user by processing at least a second set of one or more data structures comprising asset-related data. In one or more embodiments, identifying one or more account-related assets associated with the at least one user includes implementing at least one API in connection with processing at least a second set of one or more data structures, wherein implementing the at least one API includes using the at least one API to gather data, from the at least a second set of one or more data structures, pertaining to one or more of hardware assets associated with the at least one user, software assets associated with the at least one user, and access privileges attributed to the at least one user.

Step 404 includes determining one or more account-related actions to be executed, in connection with at least a portion of the one or more account-related assets, in response to detecting the occurrence of the at least one designated event pertaining to the at least one user. In at least one embodiment, determining one or more account-related actions to be executed in response to detecting the occurrence of the at least one designated event includes determining one or more account-related asset access modifications to be made with respect to the at least one user as a result of the occurrence of the at least one designated event. Additionally or alternatively, determining one or more account-related actions to be executed in response to detecting the occurrence of the at least one designated event includes identifying each of the one or more account-related actions which can be executed automatically and identifying each of the one or more account-related actions which require user input.

Step 406 includes automatically executing at least a portion of the one or more determined account-related actions. In one or more embodiments, automatically executing at least a portion of the one or more determined account-related actions includes automatically deactivating access to at least one of the one or more account-related assets for the at least one user. Additionally or alternatively, automatically executing at least a portion of the one or more determined account-related actions can include automatically transferring access to at least one of the one or more account-related assets from the at least one user to one or more additional users.

Step 408 includes performing one or more additional automated actions related to the one or more determined account-related actions and based at least in part on the at least a portion of the one or more determined account-related actions automatically executed. In at least one embodiment, performing one or more additional automated actions includes generating and outputting, to one or more users, instructions to execute at least one of the one or more determined account-related actions separate from the at least a portion of the one or more determined account-related actions automatically executed. In such an embodiment, performing one or more additional automated actions can include processing data, contained within at least a third set of one or more data structures, related to completion status of the at least one of the one or more determined account-related actions. Further, such an embodiment can include generating and outputting, to the one or more users and in accordance with one or more temporal parameters, one or more reminders pertaining to the instructions to execute the at least one of the one or more determined account-related actions based at least in part on the processing of the data related to completion status of the at least one of the one or more determined account-related actions.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically manage user account privileges based on event monitoring and related data structure processing. These and other embodiments can effectively overcome problems associated with security issues and resource-intensive ex post facto efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

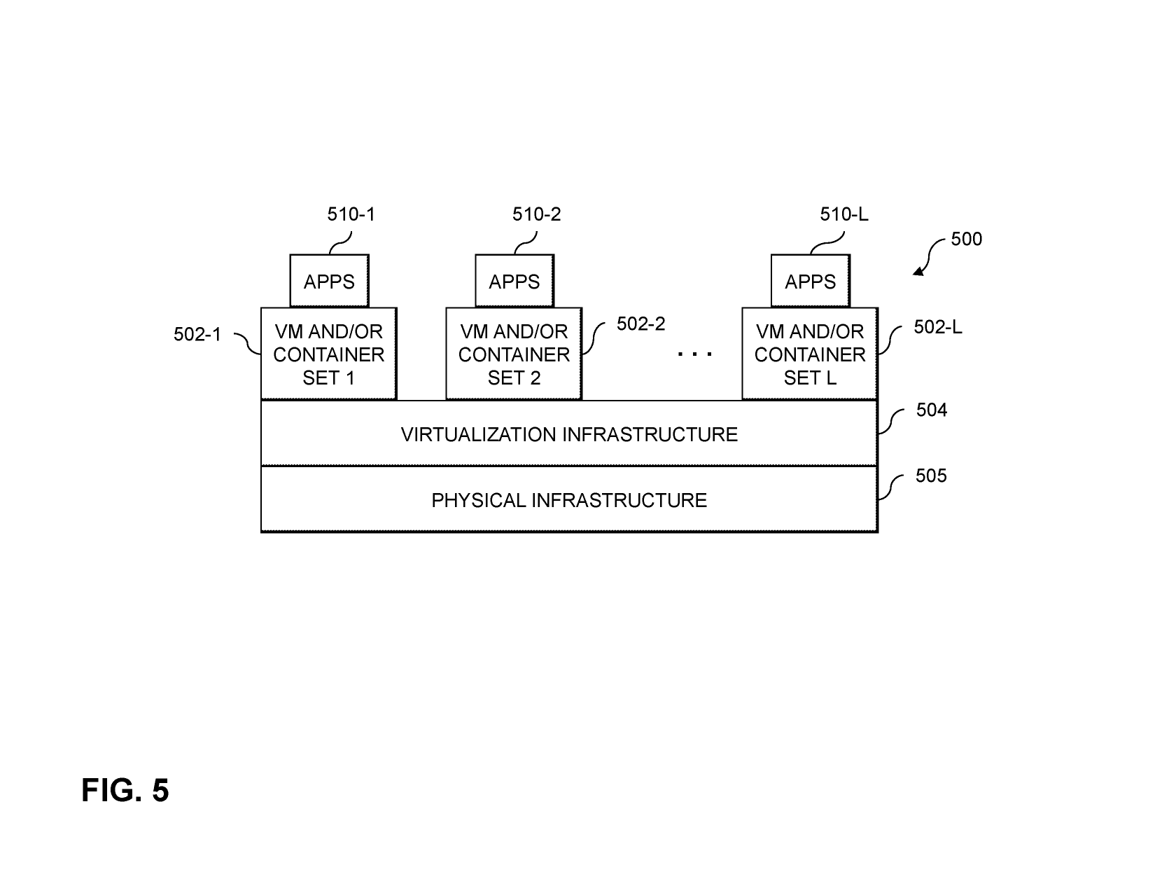

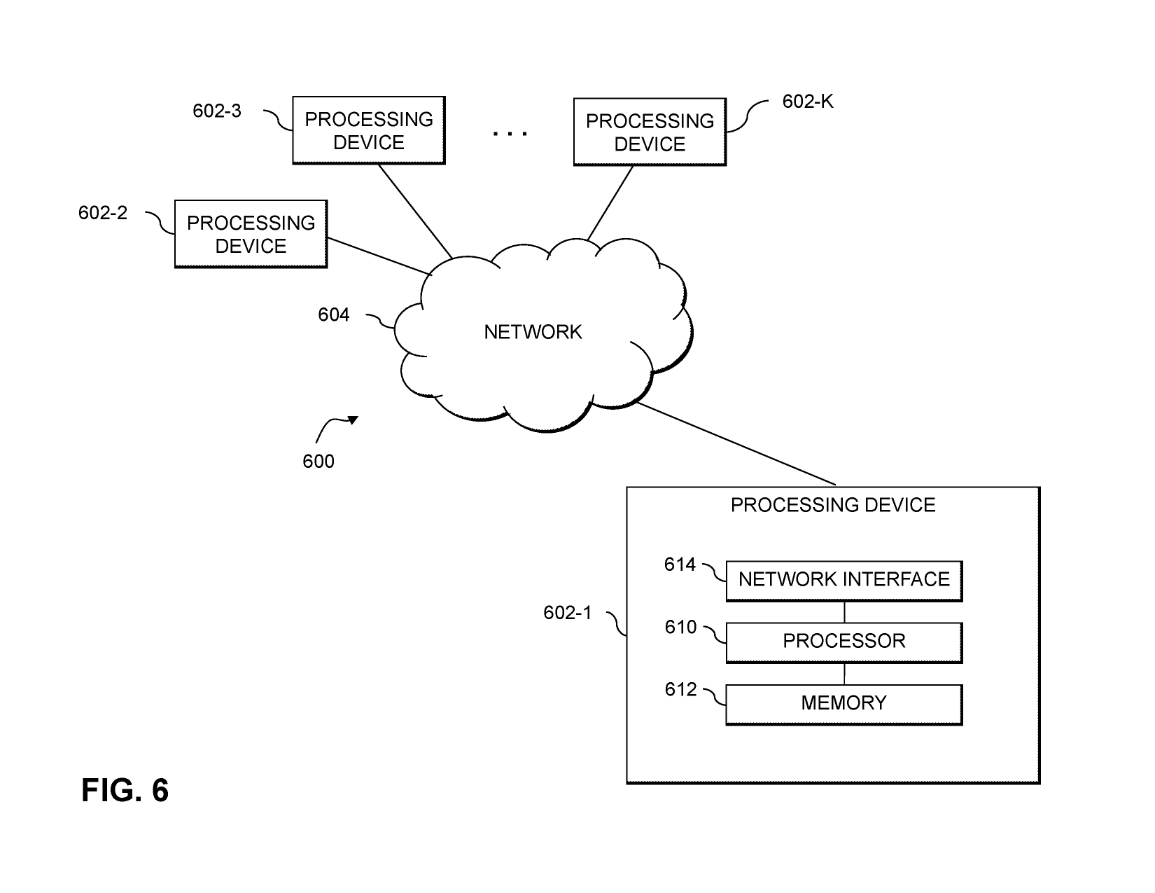

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
detecting an occurrence of at least one designated event pertaining to at least one user by processing at least a first set of one or more data structures comprising user-related data;
identifying one or more account-related assets associated with the at least one user by processing at least a second set of one or more data structures comprising asset-related data;
determining one or more account-related actions to be executed, in connection with at least a portion of the one or more account-related assets, in response to detecting the occurrence of the at least one designated event pertaining to the at least one user;
automatically executing at least a portion of the one or more determined account-related actions; and
performing one or more additional automated actions related to the one or more determined account-related actions and based at least in part on the at least a portion of the one or more determined account-related actions automatically executed;
wherein the method is performed by at least one processing device comprising a processor coupled to a memory.

2. The computer-implemented method of claim 1, wherein identifying one or more account-related assets associated with the at least one user comprises implementing at least one application programming interface (API) in connection with processing at least a second set of one or more data structures, wherein implementing the at least one API comprises using the at least one API to gather data, from the at least a second set of one or more data structures, pertaining to one or more of hardware assets associated with the at least one user, software assets associated with the at least one user, and access privileges attributed to the at least one user.

3. The computer-implemented method of claim 1, wherein determining one or more account-related actions to be executed in response to detecting the occurrence of the at least one designated event comprises determining one or more account-related asset access modifications to be made with respect to the at least one user as a result of the occurrence of the at least one designated event.

4. The computer-implemented method of claim 1, wherein determining one or more account-related actions to be executed in response to detecting the occurrence of the at least one designated event comprises identifying each of the one or more account-related actions which can be executed automatically and identifying each of the one or more account-related actions which require user input.

5. The computer-implemented method of claim 1, wherein detecting an occurrence of at least one designated event comprises detecting an occurrence of at least one event indicating a change in status of the at least one user with respect to access to at least one of the one or more account-related assets.

6. The computer-implemented method of claim 5, wherein detecting an occurrence of at least one event indicating a change in status of the at least one user with respect to access to at least one of the one or more account-related assets comprises detecting an indication of a departure of the at least one user from at least one corresponding enterprise by processing enterprise management data within the at least a first set of one or more data structures.

7. The computer-implemented method of claim 1, wherein automatically executing at least a portion of the one or more determined account-related actions comprises automatically deactivating access to at least one of the one or more account-related assets for the at least one user.

8. The computer-implemented method of claim 1, wherein automatically executing at least a portion of the one or more determined account-related actions comprises automatically transferring access to at least one of the one or more account-related assets from the at least one user to one or more additional users.

9. The computer-implemented method of claim 1, wherein performing one or more additional automated actions comprises generating and outputting, to one or more users, instructions to execute at least one of the one or more determined account-related actions separate from the at least a portion of the one or more determined account-related actions automatically executed.

10. The computer-implemented method of claim 9, wherein performing one or more additional automated actions comprises processing data, contained within at least a third set of one or more data structures, related to completion status of the at least one of the one or more determined account-related actions.

11. The computer-implemented method of claim 10, further comprising:
generating and outputting, to the one or more users and in accordance with one or more temporal parameters, one or more reminders pertaining to the instructions to execute the at least one of the one or more determined account-related actions based at least in part on the processing of the data related to completion status of the at least one of the one or more determined account-related actions.

12. A non-transitory processor-readable storage medium having stored therein program code of one or more software programs, wherein the program code when executed by at least one processing device causes the at least one processing device:
to detect an occurrence of at least one designated event pertaining to at least one user by processing at least a first set of one or more data structures comprising user-related data;
to identify one or more account-related assets associated with the at least one user by processing at least a second set of one or more data structures comprising asset-related data;
to determine one or more account-related actions to be executed, in connection with at least a portion of the one or more account-related assets, in response to detecting the occurrence of the at least one designated event pertaining to the at least one user;
to automatically execute at least a portion of the one or more determined account-related actions; and
to perform one or more additional automated actions related to the one or more determined account-related actions and based at least in part on the at least a portion of the one or more determined account-related actions automatically executed.

13. The non-transitory processor-readable storage medium of claim 12, wherein identifying one or more account-related assets associated with the at least one user comprises implementing at least one API in connection with processing at least a second set of one or more data structures, wherein implementing the at least one API comprises using the at least one API to gather data, from the at least a second set of one or more data structures, pertaining to one or more of hardware assets associated with the at least one user, software assets associated with the at least one user, and access privileges attributed to the at least one user.

14. The non-transitory processor-readable storage medium of claim 12, wherein determining one or more account-related actions to be executed in response to detecting the occurrence of the at least one designated event comprises determining one or more account-related asset access modifications to be made with respect to the at least one user as a result of the occurrence of the at least one designated event.

15. The non-transitory processor-readable storage medium of claim 12, wherein determining one or more account-related actions to be executed in response to detecting the occurrence of the at least one designated event comprises identifying each of the one or more account-related actions which can be executed automatically and identifying each of the one or more account-related actions which require user input.

16. The non-transitory processor-readable storage medium of claim 12, wherein detecting an occurrence of at least one designated event comprises detecting an occurrence of at least one event indicating a change in status of the at least one user with respect to access to at least one of the one or more account-related assets.

17. An apparatus comprising:
at least one processing device comprising a processor coupled to a memory;
the at least one processing device being configured:
to detect an occurrence of at least one designated event pertaining to at least one user by processing at least a first set of one or more data structures comprising user-related data;
to identify one or more account-related assets associated with the at least one user by processing at least a second set of one or more data structures comprising asset-related data;
to determine one or more account-related actions to be executed, in connection with at least a portion of the one or more account-related assets, in response to detecting the occurrence of the at least one designated event pertaining to the at least one user;
to automatically execute at least a portion of the one or more determined account-related actions; and
to perform one or more additional automated actions related to the one or more determined account-related actions and based at least in part on the at least a portion of the one or more determined account-related actions automatically executed.

18. The apparatus of claim 17, wherein identifying one or more account-related assets associated with the at least one user comprises implementing at least one API in connection with processing at least a second set of one or more data structures, wherein implementing the at least one API comprises using the at least one API to gather data, from the at least a second set of one or more data structures, pertaining to one or more of hardware assets associated with the at least one user, software assets associated with the at least one user, and access privileges attributed to the at least one user.

19. The apparatus of claim 17, wherein determining one or more account-related actions to be executed in response to detecting the occurrence of the at least one designated event comprises determining one or more account-related asset access modifications to be made with respect to the at least one user as a result of the occurrence of the at least one designated event.

20. The apparatus of claim 17, wherein determining one or more account-related actions to be executed in response to detecting the occurrence of the at least one designated event comprises identifying each of the one or more account-related actions which can be executed automatically and identifying each of the one or more account-related actions which require user input.
